(19) United States
(12) Patent Application Publication
(10) Pub. No.: US 2018/0184743 A1
(43) Pub. Date: Jul. 5, 2018

(54) LIGHTWEIGHT HELMET

(71) Applicant: NANOTECH CERAMICS CO., LTD., Busan (KR)

(72) Inventor: Sang-Ok JEONG, Busan (KR)

(21) Appl. No.: 15/736,317

(22) PCT Filed: Jun. 15, 2016
(86) PCT No.: PCT/KR2016/006327

§ 371 Date: Dec. 14, 2017

(30) Foreign Application Priority Data
Jun. 15, 2015 (KR) 10-2015-008486

(51) Int. Cl. A42B 3/06; A42B 3/28; A42B 3/10; A42C 2/00; B32B 5/24; B32B 5/30

(52) U.S. Cl. CPC A42B 3/063; B32B 2437/04; A42B 3/10; A42B 3/061; A42C 2/005; B32B 5/245; B32B 5/30; B32B 2250/42; B32B 2250/40; B32B 2250/44; B32B 2255/00; B32B 2262/101; B32B 2262/106; B32B 2262/0269; B32B 2262/02; B32B 2264/102; B32B 2264/10; B32B 2266/025; B32B 2266/0228; B32B 2264/108; B32B 2305/022; B32B 2305/026; B32B 2262/062; B32B 2262/0276; A42B 3/28

(57) ABSTRACT

A lightweight helmet according to an embodiment of the present invention may have a fiber sheet layer formed of a reinforced fiber, and a porous foamed plastic layer thermally bonded and formed on one surface or both surfaces of the fiber sheet layer, and the fiber sheet layer and the porous foamed plastic layer may be alternatingly formed in duplicate or more.

### CROSS-REFERENCE TO RELATED APPLICATIONS

This patent application is a national-stage application of PCT/KR2016/006327 which claims priority under 35 U.S.C. § 119 to Korean Patent Application No. 10-2015-0084186, filed on Jun. 15, 2016, in the Korean Intellectual Property Office, the disclosure of which is incorporated by reference herein in its entirety.

### TECHNICAL FIELD

The present invention relates to a lightweight helmet, and more specifically, a lightweight helmet with enhanced impact resistance and moisture absorption.

### DISCUSSION OF RELATED ART

Helmets are worn to prevent injury that may arise during a leisure activity, such as auto-cycling, car racing, inline skating, or horse riding. Helmets are required to efficiently absorb shocks or minimize damage when hit on the ground or other objects.

Generally, a helmet includes an impact absorbable body forming its basic shape to absorb impacts not to be transmitted to the wearer, an impact absorbing layer placed inside the body to mitigate impacts to the body, and a liner placed under the impact absorbing layer to provide a better feeling to the wearer when he or she puts on the helmet.

To meet the above requirements, the body of the helmet needs to have a proper degree of impact absorption to remain in its original outer look without being deformed by an impact. However, the body may be broken by an impact if it has too high stiffness. Thus, the body requires a proper degree of toughness. Also required for the body is a low specific gravity to present better wearability.

Most of helmets have been so far produced of fiber-reinforced plastic (FRP) to satisfy the above requirements. FRP is a mix of thermosetting plastic, such as unsaturated polyester or epoxy resin, and fibers, such as glass fibers, carbon fibers, or aramid fibers. FRP is a substance that meets the above-listed requirements at some degree because it is easy to process, comes with high strength and impact absorbability, and can be formed into a relatively thin sheet.

However, FRP has low toughness as compared with thermoplastics because it basically contains a thermosetting resin. Thus, the helmet may often be fractured by a large impact. Preventing this requires the helmet body to thicken, causing an increase in manufacture costs and a deterioration of wearability due to the increased weight.

An approach to resolve such problems is to make the helmet body of a thermoplastic resin. The thermoplastic resin, based on a resin matrix structure, has various organic and inorganic materials, or nonwoven fabric or knitted fabric completely buried therein. A recent trend of technology is to minimize the thickness of such resin structure, as a basic element, and to add a lightweight material, e.g., fibers, knitted fabric, or foaming material, on either or both surfaces.

Conventional techniques as such essentially adopt a FRP layer as an element constituting the helmet body and lay other materials over the FRP layer. Such helmets cannot be made light enough due to the weight of the FRP matrix resin and suffer from poor air ventilation, failing to sufficiently wick away moisture that is released as sweat and resulting in displeasure.

The above discussion of the related art is provided merely for a better understanding of the background of the present invention but should not be interpreted as admitting that it falls within the known art to one of ordinary skill in the art.

### SUMMARY

The present invention has been conceived to address the problems, and an object of the present invention is to provide a more lightweight helmet by thermally bonding a reinforced fiber layer(s) and a porous foam plastic layer(s) without using a thermosetting resin which is used as a FRP matrix. Another object of the present invention is to provide a helmet that includes a sweat absorption layer with air permeability and good moisture absorbability, presenting a pleasant feeling when worn.

To achieve the above objects, according to an embodiment of the present invention, a lightweight helmet may comprise two or more fiber sheet layers formed of a reinforced fiber and two or more porous foam plastic layers formed on one or both surfaces of the fiber sheet layers by thermal bonding, wherein the fiber sheet layers and the porous foam plastic layers may be alternately formed one over another.

According to another embodiment of the present invention, a lightweight helmet may comprise two or more fiber sheet layers formed of a reinforced fiber and two or more porous foam plastic layers formed on one or both surfaces of the fiber sheet layers by an adhesive layer, wherein the fiber sheet layers and the porous foam plastic layers are alternately formed on over another.

The lightweight helmet may further comprise a sweat absorption layer having a surface layer and an opposite surface layer and formed on an inner surface of the helmet, wherein the sweat absorption layer may include an absorption layer formed by attaching together a pair of sheets containing low melt threads between the surface layer and the opposite surface layer and dispersing porous particles between the sheets.

The fiber sheet layers may include at least one or more of a chemical fiber, a glass fiber, a carbon fiber, an aramid fiber, and an ultra-high-molecular resin fiber.

The porous foam plastic layers may include any one of any one of expanded polypropylene (EPP), expanded polystyrene (EPS), or expanded polyethylene (EPE).

The low melt threads may be threads having a structure of a sheath and a core, and the sheath may be polyester having a low melting point, and the core is polyester having a normal melting point.

The porous particles may include any one or more of silica, alumina, zeolite, and diatomite.

The porous particles may be porous carbon particles or porous high-molecular particles.

The surface layer and the opposite surface layer may be formed of cotton threads.

The lightweight helmet may further comprise an outer coat on an outer surface of the helmet.

According to the present invention, the lightweight helmet excludes a resin used as fiber reinforced plastic (FRP) as the prior art would and combines a fiber sheet layer(s) and a porous foam plastic layer(s) to provide enhanced impact resistance and air ventilation effects. Further, a sweat absorption layer is formed inside the helmet, getting rid of displeasure due to sweat.

### BRIEF DESCRIPTION OF THE DRAWINGS

FIG. 1 is a cross-sectional view illustrating a hybrid bulletproof helmet according to the prior art;

FIG. 2 is a cross-sectional view illustrating part of a lightweight helmet according to a first embodiment of the present invention;

FIG. 3 is a cross-sectional view illustrating part of a lightweight helmet according to a second embodiment of the present invention;

FIG. 4 is a cross-sectional view illustrating part of a lightweight helmet according to a third embodiment of the present invention; and

FIG. 5 is a cross-sectional view illustrating part of a lightweight helmet according to a fourth embodiment of the present invention.

### DETAILED DESCRIPTION OF EXEMPLARY EMBODIMENTS

The terms used herein are intended merely for particular embodiments and should not be intended to limit the present invention. As used herein, the singular forms “a,” “an,” and “the” are intended to include the plural forms as well, unless the context clearly indicates otherwise. As used herein, the term “comprise” or “include” is used to embody a particular characteristic, area, integer, step, operation, element, and/or component but should not be interpreted as excluding the presence or addition of other particular characteristic, area, integer, step, operation, element, component, and/or group.

Unless defined otherwise, all of the technical or scientific terms used herein should be interpreted as having the same meanings as those commonly appreciated by one of ordinary skill in the art. The terms defined in a dictionary commonly used may further be interpreted in consistence with the present disclosure, and unless defined particularly, they should not be construed as overly ideal or formal.

According to preferred embodiments of the present invention, a lightweight helmet with enhanced impact resistance and moisture absorbability is described below with reference to the accompanying drawings.

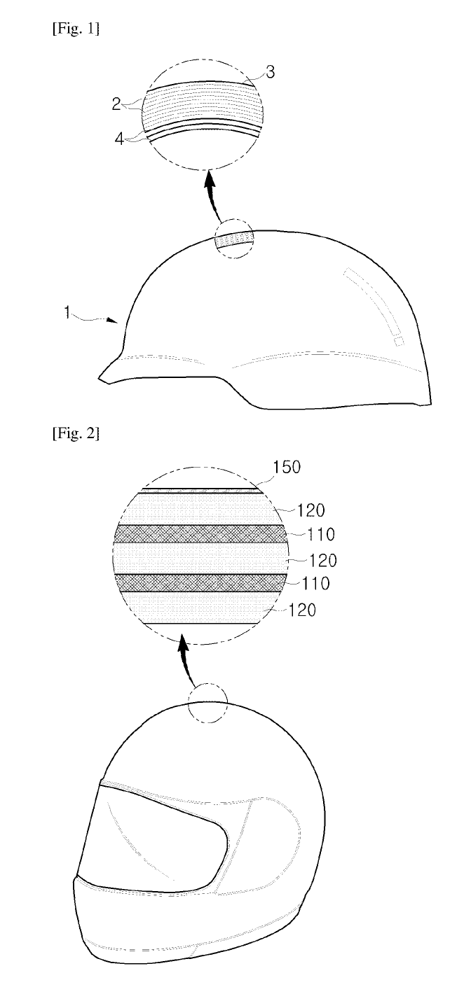

FIG. 1 is a cross-sectional view illustrating a hybrid bulletproof helmet according to the prior art. Referring to FIG. 1, the hybrid bulletproof helmet 1 is formed in a multilayer structure that includes a middle layer 2, an outer surface layer 3, and an inner surface layer 4. The inner surface layer 4 which may be a reinforced fiber layer is formed of two or three layers of aramid that are attached together. The middle layer 2 includes multiple polyethylene layers, and the outer surface layer 3 includes a single nylon layer. A composite matrix resin is applied to the inner surface layer 4 having multiple aramid fiber layers, thus failing to reduce the weight to a sufficient degree. Further, the helmet adopts a non-water-permeable material for waterproofing against the outside, causing a moisture buildup inside.

FIG. 2 is a cross-sectional view illustrating a lightweight helmet according to a first embodiment of the present invention.

Referring to FIG. 2, according to an embodiment of the present invention, the lightweight helmet includes a fiber sheet layer 110 formed of reinforced fibers and a porous foam plastic layer 120 thermally fused to one or both surfaces of the fiber sheet layer 110. Two or more fiber sheet layers 110 or two or more porous foam plastic layers 120 may be formed. Although FIG. 2 shows that two fiber sheet layers 110 and three porous foam plastic layers 120 are formed, the number of the layers 110 or the layers 120 may be changed as necessary. Such formation of the multiple layers may lead to increased impact resistance and impact absorbability.

The fiber sheet layer 110 may include at least one or more of chemical fibers, glass fibers, carbon fibers, aramid fibers, and ultra-high-molecular resin fibers, as the reinforced fibers. The fiber sheet layer 110 may be implemented in various forms, such as a knitted fabric, woven fabric, or nonwoven fabric, but not limited to such particular form.

In particular, nonwoven fabric, when used to form the fiber sheet layer 110, shows low apparent density and good air permeability, allowing it to be suitable for the fiber sheet layer 110. Nonwoven fabric may filter in even very fine particles thanks to its high density, enabling a filter-out of liquids or gases. Such filter-out functionality leads to very high gas or liquid permeability, allowing air or other gases to freely come in or out, i.e., high air permeability. High air permeability refers to a porous structure with many empty spaces between the fibers and plays a role to reduce the apparent density of the fiber sheet layer 110 and the overall weight of the helmet.

The use of aramid fibers leads to good thermal resistance and high tensile strength and elasticity, enabling a bulletproofing capability. Various types of aramid fabric may come in use, e.g., aramid fabrics capable of good bulletproofing and relatively easy to manufacture. To make a woven aramid fabric, aramid fibers are used as warp threads to form a warp beam, and the warp beam is then placed in a weaving machine, then woven together with weft threads of aramid fibers. In this case, the aramid fabric may be formed in a plain weave or basket weave pattern. The plain or basket weave pattern has warp and weft threads formed to have constant bends and may thus evenly spread an external force from, e.g., a bullet, over the overall fabric, presenting excellent bullet proofing.

The ultra-high-molecular resin fibers may be formed of, e.g., ultra-high-molecular polyethylene, ultra-high-molecular polypropylene, or ultra-high-molecular polyester or other resins. The ultra-high-molecular resin is a substance whose mean molecular mass amounts to one million or more, has a linear molecular sieve structure, and exhibits good wear-resistance or high strength. As such, use of the ultra-high-molecular resin fibers with high impact-resistant strength for the fiber sheet layer may afford the fiber sheet layer increased impact-resistant strength.

The porous foam plastic layer(s) 120 may be formed on one or both surfaces of the fiber sheet layer 110. Preferably, two or more fiber sheet layers 110 and two or more porous foam plastic layers 120 may be layered one over another. Basically, the porous foam plastic layer 120 is preferably formed on the inside of the helmet, but may also be formed on the outside of the helmet. More preferably, the porous foam plastic layer 120 may be formed on each of both surfaces of the fiber sheet layer 110. Forming the porous foam plastic layer 120 on each of both surfaces of the fiber sheet layer 110 may enhance impact absorption and prevent the fiber sheet layer 110 from being exposed to the outside, thus avoiding damage to the fiber sheet layer 110.

The porous foam plastic layer 120 may be formed of any one selected from among expanded polypropylene (EPP), expanded polystyrene (EPS), or expanded polyethylene (EPE). The form plastic is a plastic adapted to have a tiny foam-type structure therein by a foaming agent.

Expanded polystyrene (EPS) is a sort of polystyrene which is a general-purpose plastic, is used as a thermal insulator thanks to its low thermal conductivity, and exhibits good anti-shock effects against external impacts. Among other foaming plastics, EPS has the lowest density and may advantageously be reused. However, EPS may create a large amount of dioxin when heated, rendering it difficult to recycle. Further. EPS is vulnerable to repeated impacts. Thus, it is more preferable to use EPP or EPE.

As such, the impact absorbing fiber composite formed by thermally fusing the fiber sheet layer 110 and the porous foam plastic layer 120 does not employ a matrix resin that the prior art does, leading to a significant reduction in weight (it is lighter than FRP) and enhanced impact resistance.

An outer coat may be provided on the outer surface of the helmet. The outer coat may prevent damage to the porous foam plastic layer 120 or fiber sheet layer 110 exposed to the outside of the helmet while allowing it to be painted. The outer coat may be formed as, as thin a film as about 0.01 mm to 0.8 mm by fusing a thermosetting or thermoplastic resin onto the outer surface of the helmet. The outer coat may be painted, giving the helmet an aesthetic look.

As such, according to an embodiment of the present invention, the fiber sheet layers 110 and the porous foam plastic layers 120 are alternately layered one over another so that air can pass therethrough in a predetermined space, securing air permeability and allowing for smooth air circulation, thus getting rid of displeasure that may arise from sweat inside the helmet. For more efficient removal of moisture inside the helmet, a sweat absorption layer 130 may be further provided on the inner surface of the helmet.

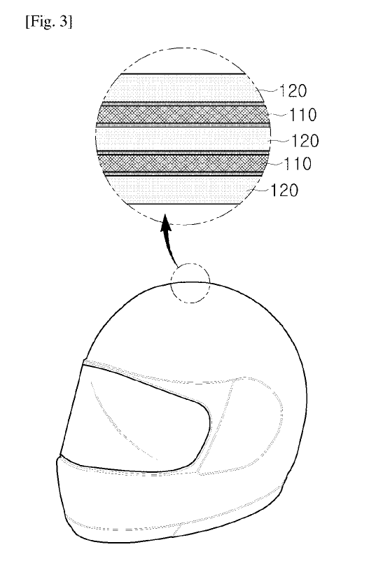

FIG. 3 is a cross-sectional view illustrating part of a lightweight helmet according to a second embodiment of the present invention. Referring to FIG. 3, according to an embodiment of the present invention, the lightweight helmet includes a fiber sheet layer 110 formed of reinforced fibers and a porous foam plastic layer 120 attached by an adhesive layer onto one or both surfaces of the fiber sheet layer 110. Two or more fiber sheet layers 110 and two or more porous foam plastic layers 120 may be formed. As compared with the first embodiment, the fiber sheet layer 110 and the porous foam plastic layer 120 may be attached not by thermal bonding but by the adhesive layer. As such, attaching the fiber sheet layer 110 with the porous foam plastic layer 120 may be done by a separate adhesive layer, rather than thermal fusing. The other configuration is the same as that given for the first embodiment.

The adhesive layer may be formed of an adhesive typically used. The adhesive used herein may include, but is not limited to, an inorganic adhesive, a resin-based inorganic adhesive, a rubber adhesive, an epoxy adhesive, or a ultraviolet (UV)-cured adhesive.

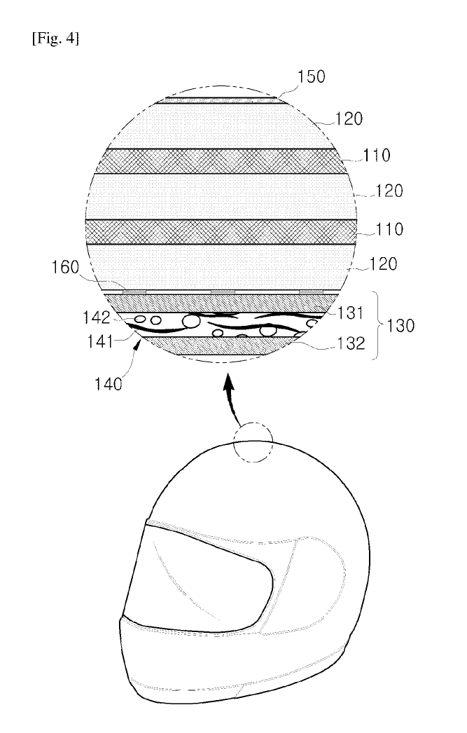

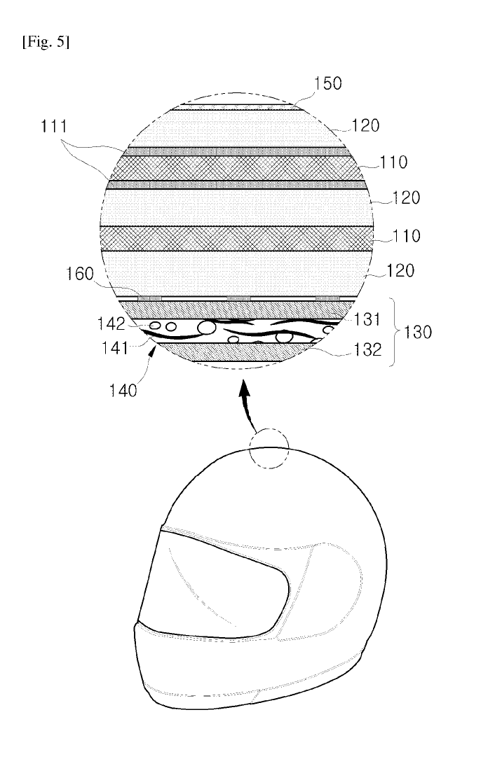

FIG. 4 is a cross-sectional view illustrating a lightweight helmet according to a third embodiment of the present invention. Referring to FIG. 4, a sweat absorption layer 130 may be further provided on an inner surface of the helmet. The sweat absorption layer 130 may include a surface layer 131, an opposite surface layer 132, and absorption layer 140 between the surface layer 131 and the opposite surface layer 132. The absorption layer 140 includes porous particles 142 dispersed therein to absorb water and low melt fibers 141 for supporting the porous particles 142 to spread. The absorption layer 140 may be formed by attaching together a pair of sheets including low melt fibers and spreading porous particles between the sheets.

The low melt fibers 141 may be sheath/core-structured threads, which may be formed of polyester that has a low melting point, and the core may be formed of polyester that has a normal melting point. The low melting point refers to being relatively lower in temperature than the melting point of the polyester used for the core. In other words, the basic temperature indicating the low melting point is not a temperature particularly determined but may rather be flexibly varied depending on the type of polyester used for the core. After putting the porous particles 142 between the sheets including the low melt fibers 141, they are heated at a temperature between 160° C. to 240° C. which is lower than that of the normal polyester and higher than that of the low melt fibers 141, and the sheath part of the low melt fibers 141 is deformed, leading to easier fusion between the threads. Thus, a bonding effect may be shown even without performing a special after-treatment. As the porous particles 142 are positioned between the polyester fibers, water permeating through the surface layer 131 or the opposite surface layer 132 may be sucked or absorbed into the multiple pores of the porous particles 142.

The porous particles 142 have multiple pores in the surface or inside and are typically in the form of a powder. The porous particles 142 absorb water through the capillary action of the pores. The type of the particles is not particularly limited as long as they have pores. When a ceramic material is put to use, silica, alumina, zeolite, or diatomite may be suitable among porous ceramics. Deodorization, but not only water absorption, may also be expected from the formation of tiny pores.

In particular, zeolites are minerals obtained from volcanic rocks, a sort of aluminosilicate minerals containing alkali metals or alkali-earth metals, having a three-dimensional net structure built of tetrahedra linked to each other, with a large gap in the center thereof and pores in the frame which are created by the irregularity of the net structure. The pores may absorb a great amount of water while serving as a molecular sieve, remain in shape even at a high temperature and suck and hold ammonia, heavy metal, or other toxic materials even when they are saturated. Further, zeolites may also be used as filtering materials, and they may freely exchange their own cations with other cations. These properties enable removal, concentration, and recovery of harmful substances.

The porous particles may also be porous high-molecular particles or porous carbon particles. Such porous organic particles have high absorbability as well as adsorption or suck-in of contaminants.

The surface layer 131 and the opposite surface layer 132 preferably include cotton threads. Cotton threads, although generally used in a woven fabric, may form a layer in other ways. When the layer 131 and the 132 include cotton threads, the cotton threads may absorb water and transmit the water to the internal absorption layer 140, and they are then smoothed back, allowing them to feel pleasant when used for the surface in contact with the human body. In particular, they may be used in the circumference of caps or helmets or under-the-arm portions of shirts, rapidly absorbing sweat and giving a pleasant feeling. Although the surface layer 131 and the opposite surface layer 132 are formed of cotton threads, other various types of water-permeable fibers or threads may also be used.

The sweat absorption layer 130 may be formed over the whole inner surface of the helmet, and as necessary, the position or thickness of the sweat absorption layer 130 may be changed. In particular, when the sweat absorption layer 130 is formed in the shape of a band around the user's neck or forehead where it directly contacts the user's skin in the helmet, it may provide a good moisture absorbable effect even in its small size of area.

The sweat absorption layer 130 and the porous foam plastic layer 120 may be layered one over the other. The sweat absorption layer 130 and the porous foam plastic layer 120 may be attached together using a separate attaching material 160. Various types of attaching materials 160 may be used, e.g., detachable Velcro tapes. The sweat absorption layer 130 and the porous foam plastic layer 120 may be attached by thermal bonding that heats the porous foam plastic layer 120, without using a separate attaching material. Various methods for forming the sweat absorption layer 130 on the inner surface of the helmet may apply but not limited to a particular method.

FIG. 5 is a cross-sectional view illustrating part of a lightweight helmet according to a fourth embodiment of the present invention. Referring to FIG. 5, according to the fourth embodiment of the present invention, the lightweight helmet includes a fiber sheet layer 110 and a porous foam plastic layer 120 attached by an adhesive layer, not by thermal bonding. As such, the attachment of the fiber sheet layer 110 and the porous foam plastic layer 120 may be carried out by a separate adhesive layer, rather than thermal bonding, and the other configuration of the lightweight helmet is the same as that of the third embodiment.

The adhesive layer may be formed of an adhesive commonly used. The adhesive used here may include, but is not limited to, e.g., an inorganic adhesive, a resin-based inorganic adhesive, a rubber adhesive, an epoxy adhesive, or a UV-cured adhesive.

Although embodiments of the present invention have been described with reference to the accompanying drawings, it will be appreciated by one of ordinary skill in the art that other various changes may be made thereto without departing from the essential features or technical spirit of the present invention.

Thus, the embodiments described above are exemplary in all aspects, but not intended as limiting the present invention. The scope of the present invention should be defined by the appended claims, not by the above detailed description and should be construed as encompassing all modifications, changes, or variations as derived the meanings or scope and equivalents of the present invention.

| | |
|---|---|
| 100: helmet | 110: fiber sheet layer |
| 120: porous foam plastic layer | 130: sweat absorption layer |
| 131: surface layer | 132: opposite surface layer |
| 140: absorption layer | 141: low melt thread |
| 142: porous particle | |

1. A lightweight helmet, comprising:
two or more fiber sheet layers formed of a reinforced fiber; and
two or more porous foam plastic layers formed on one or both surfaces of the fiber sheet layers by thermal bonding, wherein the fiber sheet layers and the porous foam plastic layers are alternately formed one over another.

2. A lightweight helmet, comprising:
two or more fiber sheet layers formed of a reinforced fiber; and
two or more porous foam plastic layers formed on one or both surfaces of the fiber sheet layers by an adhesive layer, wherein the fiber sheet layers and the porous foam plastic layers are alternately formed on over another.

3. The lightweight helmet of claim 1, further comprising a sweat absorption layer having a surface layer and an opposite surface layer and formed on an inner surface of the helmet, wherein the sweat absorption layer includes an absorption layer formed by attaching together a pair of sheets containing low melt threads between the surface layer and the opposite surface layer and dispersing porous particles between the sheets.

4. The lightweight helmet of claim 1, wherein the fiber sheet layers include at least one or more of a chemical fiber, a glass fiber, a carbon fiber, an aramid fiber, and an ultra-high-molecular resin fiber.

5. The lightweight helmet of claim 1, wherein the porous foam plastic layers include any one of any one of expanded polypropylene (EPP), expanded polystyrene (EPS), or expanded polyethylene (EPE).

6. The lightweight helmet of claim 3, wherein the low melt threads are threads having a structure of a sheath and a core, and wherein the sheath is polyester having a low melting point, and the core is polyester having a normal melting point.

7. The lightweight helmet of claim 3, wherein the porous particles include any one or more of silica, alumina, zeolite, and diatomite.

8. The lightweight helmet of claim 3, wherein the porous particles are porous carbon particles or porous high-molecular particles.

9. The lightweight helmet of claim 3, wherein the surface layer and the opposite surface layer are formed of cotton threads.

10. The lightweight helmet of claim 1, further comprising an outer coat on an outer surface of the helmet.

11. A lightweight helmet, comprising a sweat absorption layer formed on an inner surface of the lightweight helmet, the sweat absorption layer having a surface layer and an opposite surface layer, wherein the sweat absorption layer includes an absorption layer formed by attaching together a pair of sheets containing low melt threads between the surface layer and the opposite surface layer and dispersing porous particles between the sheets.

12. The lightweight helmet of claim 11, wherein two or more fiber sheet layers are formed of a reinforced fiber on an outer surface of the sweat absorption layer, and two or more porous foam plastic layers are formed on one or both surfaces of the fiber sheet layers by thermal bonding, and wherein the fiber sheet layers and the porous foam plastic layers are alternately formed one over another.

13. The lightweight helmet of claim 11, wherein two or more fiber sheet layers are formed of a reinforced fiber on an outer surface of the sweat absorption layer, and two or more porous foam plastic layers are formed on one or both surfaces of the fiber sheet layers by an adhesive layer, and wherein the fiber sheet layers and the porous foam plastic layers are alternately formed one over another.

14. The lightweight helmet of claim 11, wherein the low melt threads are threads having a structure of a sheath and a core, and wherein the sheath is polyester having a low melting point, and the core is polyester having a normal melting point.

15. The lightweight helmet of claim 11, wherein the porous particles include any one or more of silica, alumina, zeolite, and diatomite.

16. The lightweight helmet of claim 11, wherein the porous particles are porous carbon particles or porous high-molecular particles.

17. The lightweight helmet of claim 11, wherein the surface layer and the opposite surface layer are formed of cotton threads.
